(19) United States
(12) Patent Application Publication
(10) Pub. No.: US 2012/0234006 A1
(43) Pub. Date: Sep. 20, 2012

(54) OCEAN THERMAL ENERGY CONVERSION COUNTER-CURRENT HEAT TRANSFER SYSTEM

(76) Inventor: James R. Baird, Nanaimo (CA)

(21) Appl. No.: 13/416,065

(22) Filed: Mar. 9, 2012

(30) Foreign Application Priority Data
Mar. 16, 2011 (CA) 2734638

(51) Int. Cl. F03G 7/05

(52) U.S. Cl. 60/641.7

(57) ABSTRACT

For OTEC (Ocean Thermal Energy Conversion), rather than transferring large quantities of surface heat from near the ocean surface used to vaporize a working fluid to drive a heat engine (turbine) and generator to the deep ocean to provide a heat sink, this invention provides a method of using small masses of low-boiling-point fluids to absorb heat in a heat pipe near the ocean surface using the latent heat of evaporation and returning the heat of condensation of the vapor in a condensed working fluid pumped back to the ocean surface in a counter-current heat pipe system. The counter-current flow minimizes the amount of heat that is absorbed from the surface to vaporize the working fluid as well as the mount of heat dumped into the deep ocean.

This invention relates to an improved method for condensing and vaporizing a working fluid in an Ocean Thermal Energy Conversion (OTEC) system.

OTEC is a form of ocean energy extraction first proposed in France in 1881, with the first operating plant built in Cuba in 1930. Since then, a number of small projects have been developed, mostly as research or demonstration projects, but the technology hasn't been widely adopted mainly due to cost.

OTEC facilities generally have a high capital cost per unit of power produced. Interest in OTEC tends to follow cost spikes in oil and energy pricing. Large cold water pipes of a length of 1000 metres long and a diameter as great as 10 metres are one of the main drivers of cost for conventional OTEC. Manufacturing such large pipes is difficult and they are difficult to install and maintain in the adverse environmental conditions encountered offshore. The weight of these pipes mandate that the platforms that support them must also be great and therefore costly.

OTEC is a means to extract some of the solar energy stored in the upper mixed layer of tropical oceans. Typically, an appropriate working fluid produces mechanical work in a Rankine cycle operated between warm surface seawater and cold deep seawater. Because practical seawater temperature differences are only of the order of 20° C., the cycle thermodynamic efficiency is low and as a result, conventional OTEC electricity generation requires very large seawater flow rates of the order of several cubic metres per second per megawatt. These large flow rates drive the need for the large piping.

British Patent No. GB 2395754 to Michaelis proposes a heat pipe, located in deep cold waters, as a means of overcoming the cost and environmental difficulties associated with the massive cold water pipes characteristic of conventional OTEC. Vaporized working fluid, having driven a surface-mounted turbo-generator, is transferred down a conduit to the heat pipe being formed of heat exchangers taking the cooled vapor back to its liquid state. It runs into a sump from which it is pumped up by a single pump, or a series of pumps linked to break tanks, through an insulated tube back to the surface, where heat exchangers expose it to surface water heat. This causes the condensed working fluid to vaporize, driving the turbo-generator, the vapor being returned again to the heat pipe, to complete the cycle.

US Patent Application 2007/0289303, Inventor Prueitt, describes a method of using small masses of low-boiling-point fluids to absorb heat in a heat exchanger near the ocean surface using the latent heat of evaporation and then depositing the latent heat of condensation in a deep ocean heat exchanger, using the cold seawater as a heat sink. The condensed liquid is pumped back to the ocean surface. The heat engine (turbine) and generator can be at the ocean surface, or it can be in deep ocean. By using a fluid that transfers heat by evaporation and condensation, much larger quantities of heat can be moved per kilogram of fluid than can be transferred by moving the same mass of seawater.

Both of the above noted applications result in the transfer of large amounts of heat from the warm surface waters to the deep ocean to condense the vapor of a low boiling point fluid. Such large heat transfers reduce the thermodynamic efficiency of the heat cycle and ultimately limit the amount of power that can be derived from the world's oceans using OTEC.

Interest in OTEC surged with the price of oil in the seventies. As energy markets stabilized, however, this enthusiasm waned and the more ambitious existing OTEC R&D programs were completed by the 1990s without near-term prospects of commercial implementation. Many involved researchers have remained advocates for OTEC and recent concerns about secure energy supplies, fossil fuel burning and climate change as well as strong demand-based on the increases in the cost of primary energy has rekindled enthusiasm for renewable energy. In particular, the vast baseload OTEC resource seems attractive but the theoretical question of the actual size of the OTEC resource has yet to be resolved.

A wide range of estimates of OTEC's potential, from 10 to 1000 terawatts (TW) exist in the recent technical literature. The high-end values generally are derived from the amount of solar radiation absorbed by tropical oceans, while the low-end figures are quoted without details.

According to the 2007 study of Gérard C. Nihous, Associate Researcher, Hawaii Natural Energy Institute, University of Hawaii, published in the March issue of Journal of Energy Resources Technology, “about 5 TW of steady-state OTEC power may be available worldwide at most.”

Estimates of total primary energy requirements from all sources by the year 2050, when the global population is expected to be as great as 10 billion, many of whom will be seeking living standards comparable to those in the developed world, range from between 30 TW and 60 TW, up from roughly 16 TW currently.

Were 5 TW the maximum steady-state power available from conventional OTEC, then OTEC could not fill the gap between current energy demands and those predicted.

Nihous bases his assumption on seawater flow rate calculations which predict small transient cooling of the tropical mixed layer, which would temporarily allow heat flow into the oceanic water column generating a long-term steady-state warming of deep tropical waters, and the corresponding degradation of OTEC resources at deep cold seawater flow rates per unit area of the order of the average abyssal upwelling creating a potential to modify the oceanic thermohaline circulation.

Poleward heat flow in the ocean is about a petawatt bringing warm equatorial water to the polar seas where it cools to the freezing point of seawater and sinks to the sea floor. This cold water flows along the sea floor upwelling everywhere where it is balanced in the water column by warm water diffusing down from the surface creating the characteristic ocean temperature vertical profile where most of temperature change occurs in the thermocline—roughly the first 500 metres of depth. What powers this so-called thermohaline circulation is the equator-to-pole density gradient due to temperature and salinity gradients at the surface.

Conventional OTEC pumps cold (nutrient rich) water to the surface and dumps the heated water back to the deep (though the thermohaline circulation) to extract mechanical energy via a heat engine. Because the temperature changes are small compared to the absolute heat rejection temperature, and because of large parasitic losses from pumping, the thermodynamic efficiency of conventional OTEC is low—around 2%. For every watt of electricity extracted therefore 50 watts of heat flows between the surface and deep ocean—the net effect of which is to warm the deep ocean (and to bring nutrients to the surface). 30 TW electrical at the surface requires a surface to deep heat flow=(30̂13 W/0.02)=15̂15 W=1.5 petawatt, or enough to collapse the thermohaline circulation.

Producing conventional OTEC power; the ocean would tend to get more isothermal vertically as more energy is extracted pumping heat and the biology of the oceans would be disrupted as nutrients from the deep first fertilized surface plankton and then eutrophy the water column, much as fertilizer and detergent runoff from terrestrial rivers do.

It is evident therefore that in order for OTEC to meet the projected need for primary energy in the future it must be available at less cost and must have less of an impact on both the ocean's biology as well as the thermohaline circulation.

Reducing OTEC's cost and environmental impacts is accomplished by the current invention by means of a counter-current heat pipe in which the condensation of a working fluid takes place in the core of a heat pipe and the heat of condensation is circulated back to the surface by means of a counter-current flow of the condensed working fluid in a segregated channel of the heat pipe. The counter-current flow minimizes the amount of heat that is extracted from warm surface waters and in turn is dumped into the cool, deeper, waters.

The novel features which are considered characteristic of the invention are set forth in the appended claims. The invention itself, however, both as to its construction and as to its method of operation, together with additional objects and advantages thereof, will be best understood from the following description of the specific embodiments when read and understood in connection with the accompanying drawings. Attention is called to the fact, however, that the drawings are illustrative only, and that changes may be made in the specific construction illustrated and described within the scope of the appended claims.

Other objects and advantages of the present invention will be apparent upon consideration of the following specification, with reference to the accompanying drawings in which like numerals correspond to like parts shown in the drawings.

A specific embodiment of the invention will now be described by way of example with reference to the accompanying drawings in which:

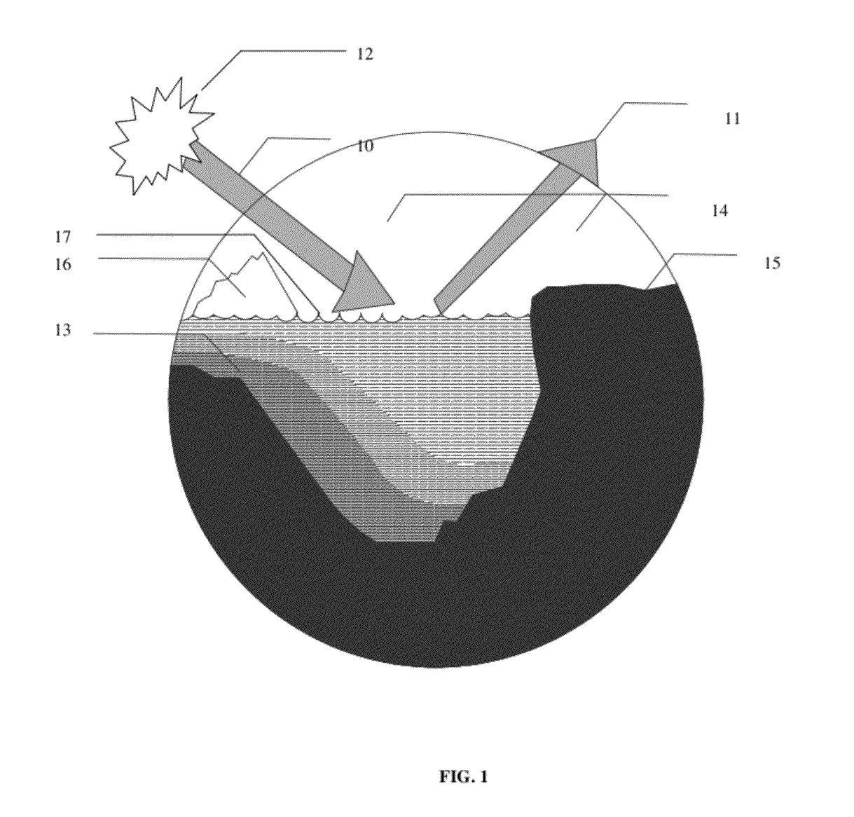

FIG. 1 shows in diagrammatical form the absorption of the global radiative imbalance.

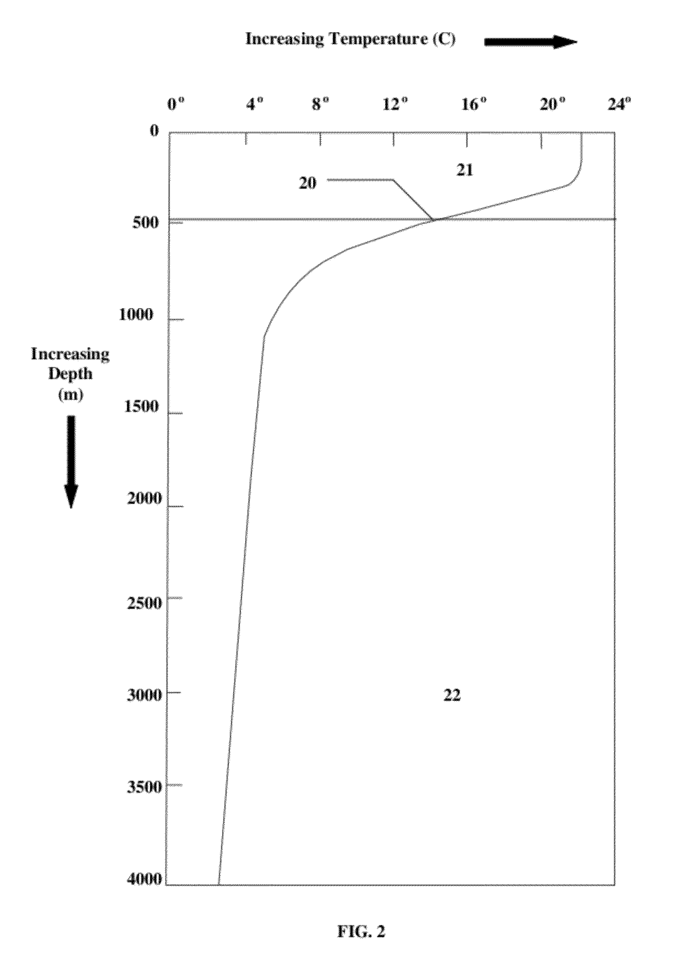

FIG. 2 shows in diagrammatical form the ocean's thermocline.

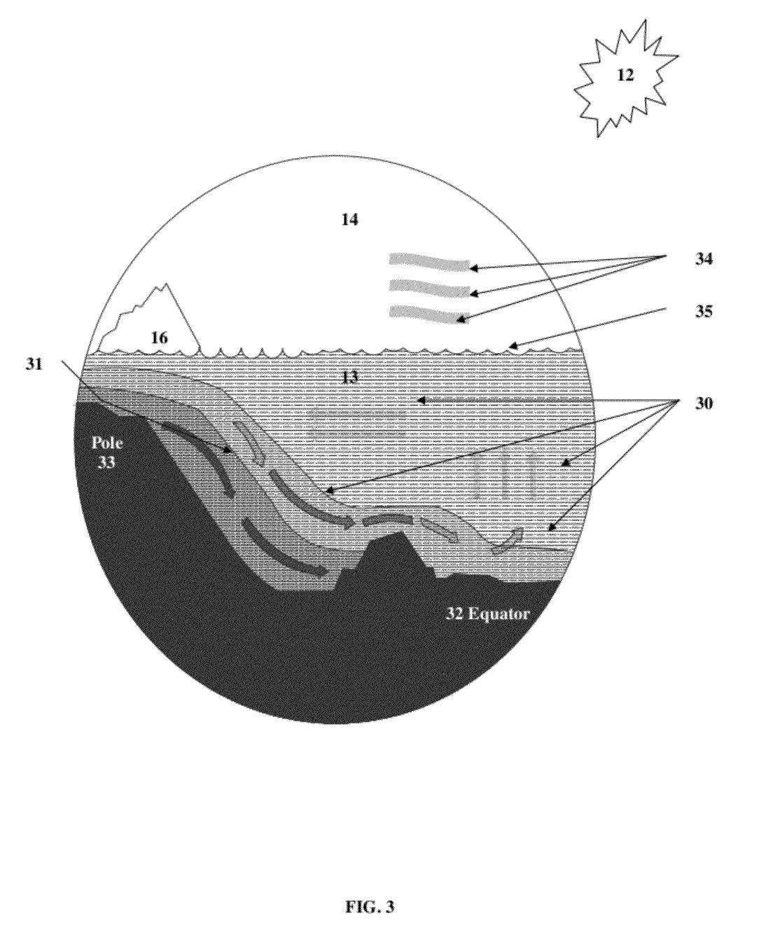

FIG. 3 shows in diagrammatical form heat convection in the ocean.

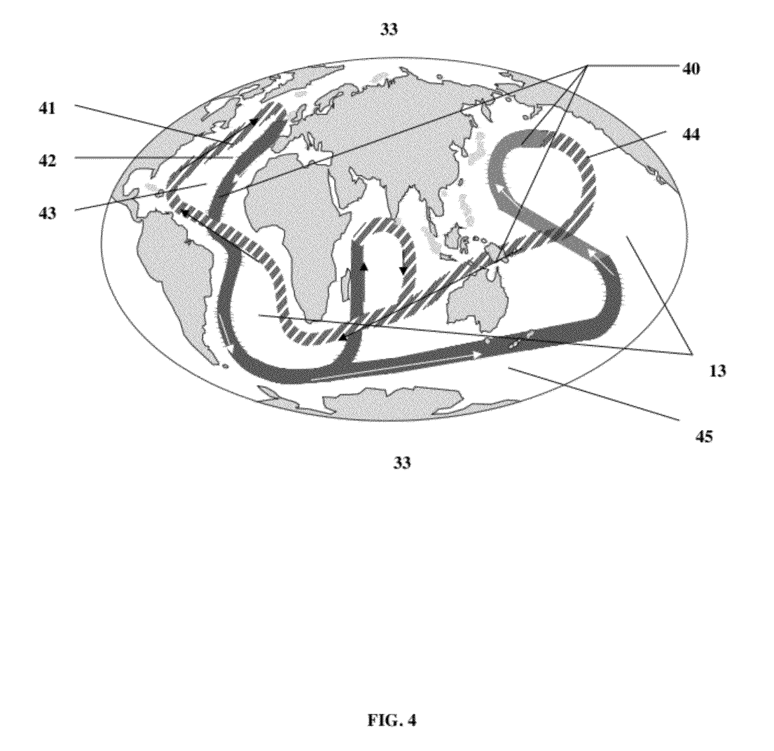

FIG. 4 shows in diagrammatical form thermohaline circulation.

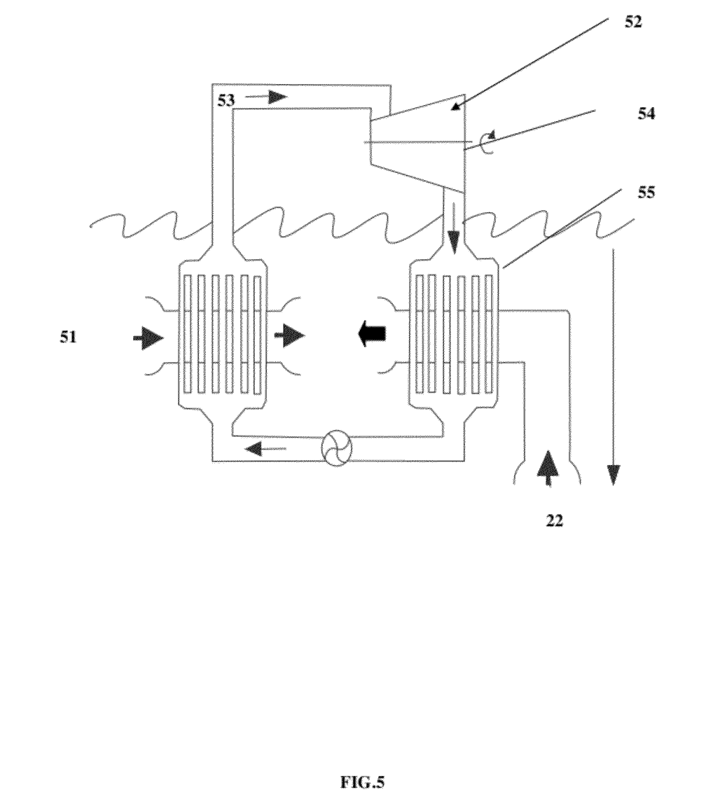

FIG. 5 shows a schematic of an OTEC system of the prior art.

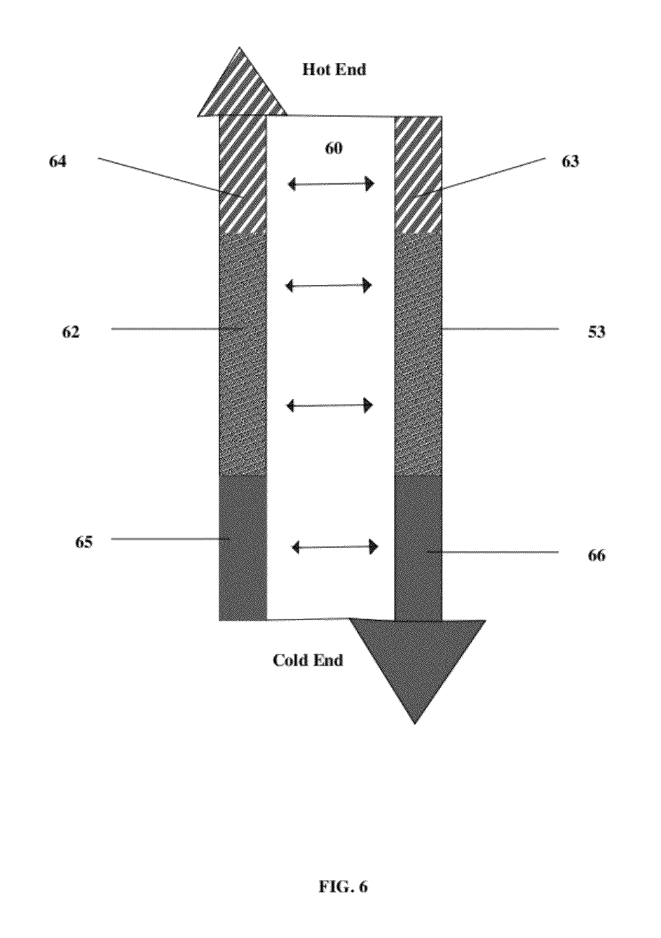

FIG. 6 shows in diagrammatical form counter-current heat exchange of the prior art.

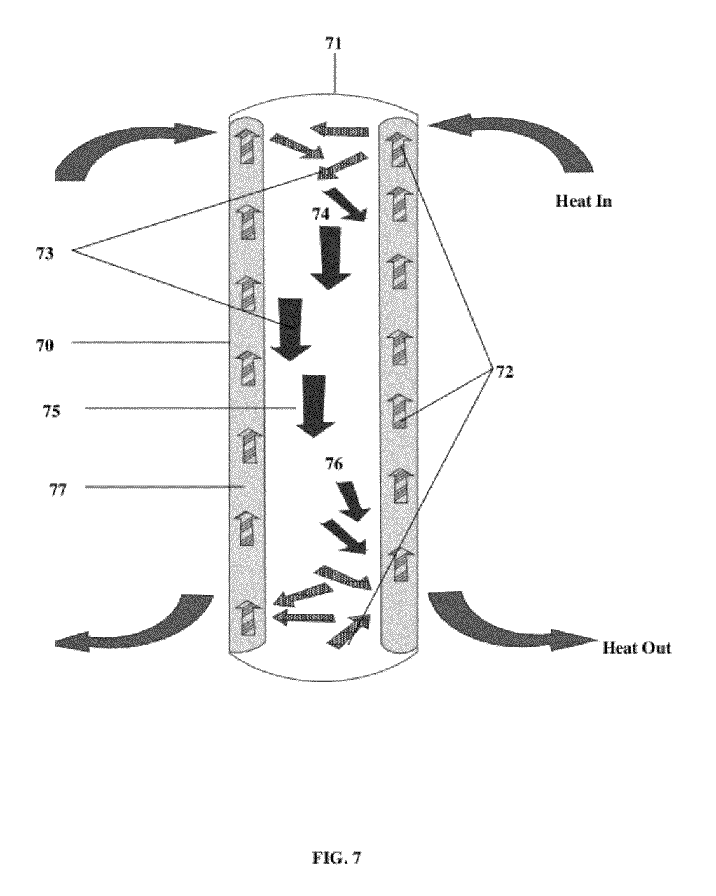

FIG. 7 shows a sectional elevation of a heat pipe of the prior art.

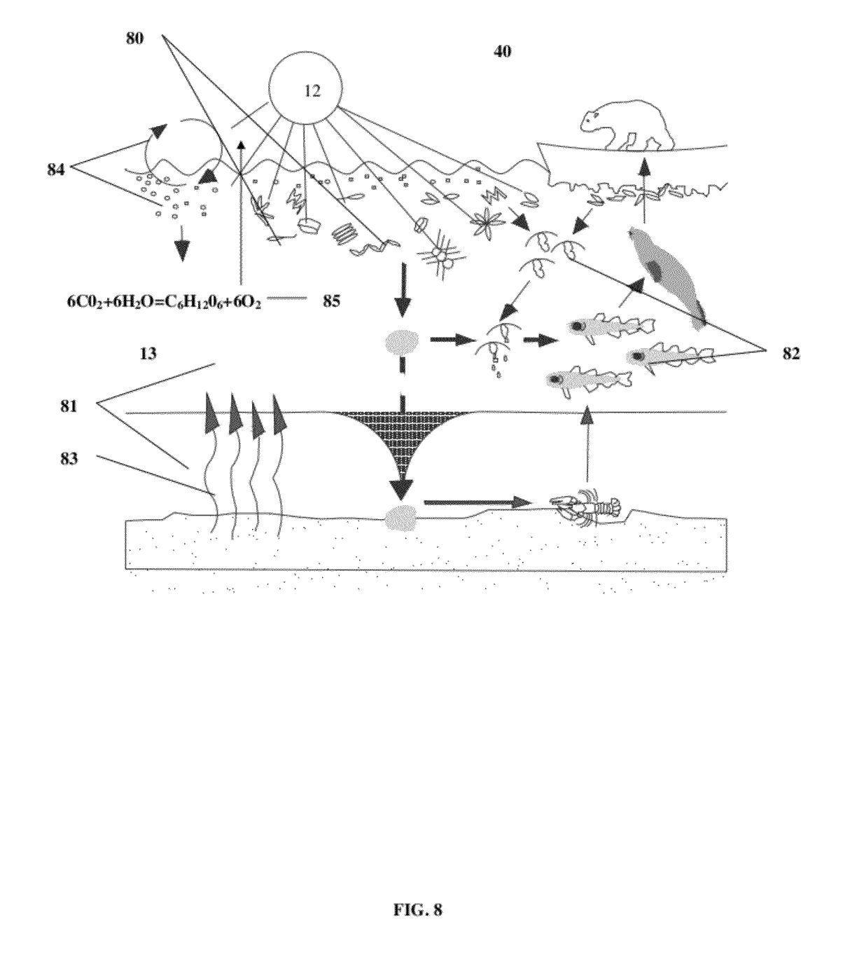

FIG. 8 is a schematic of the oceanic food cycle.

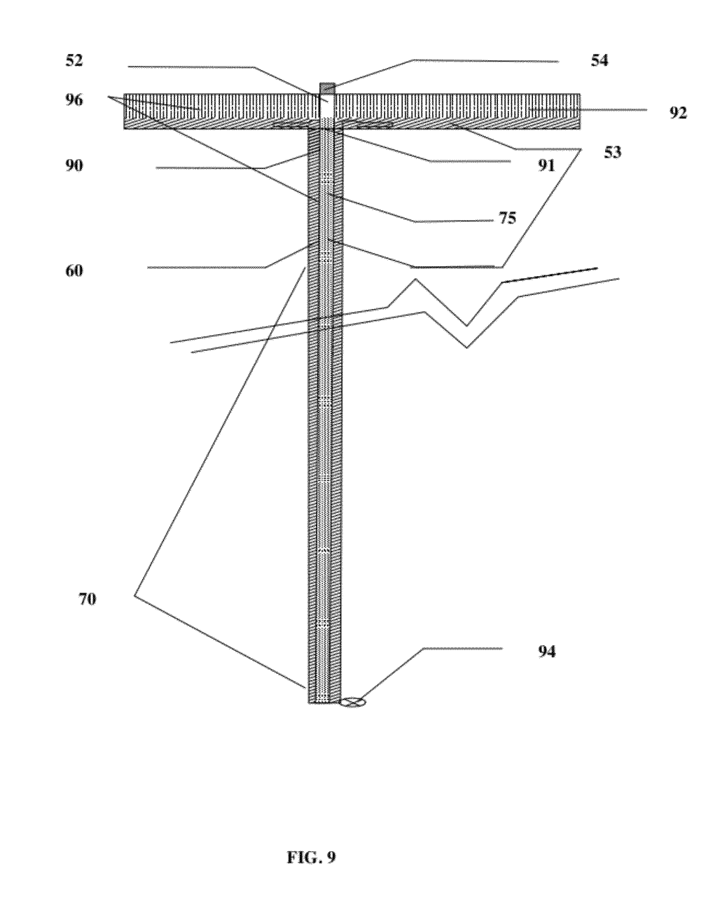

FIG. 9 shows a sectional elevation of an OTEC system utilizing a counter-current heat transfer system.

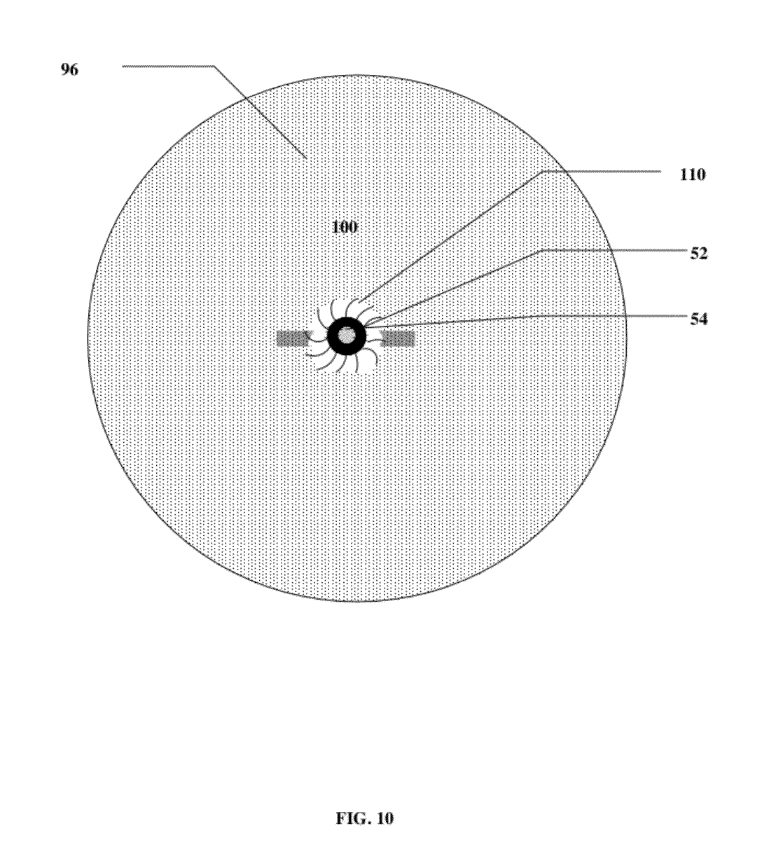

FIG. 10 shows a plan view of the upper section of an OTEC system utilizing a counter-current heat transfer system.

Referring to FIG. 1, the global radiative imbalance is the difference between the incoming (10) and outgoing (11) thermal radiation of the Sun's energy (12).

Ernest Moniz, director of the MIT Energy Initiative, recently pointed out that, with respect to clean energy, solar power “is ultimately the real game changer . . . the big Achilles heel” of solar electricity is that the sun doesn't shine 24 hours a day, so ways have to be found to store it to avoid disruptions.

The greatest source of energy in the solar system is the Sun 12 and due to the global radiative imbalance, more than enough of this energy is being stored in the world's oceans (13) to produce all of the primary energy mankind requires or will require for the foreseeable future.

Eighteen times more heat has been stored in the oceans 13 since the mid 1950s due to global warming than has been stored in the atmosphere (14). So much heat is absorbed by the oceans 13, that the warming of the earth's atmosphere 14 by greenhouse gases is slowed.

According to S. Levitus and J. Antonov, et al. in a 2005 paper, “Warming of the world ocean”, 0.84% of the energy available to warm earth's surface has gone into the ocean 13 during the 48 years from 1955 to 2003; 5% has gone into the land; (15) 4% has gone into the atmosphere 14; and the remainder has gone into melting ice (16).

Most of the sunlight 12 absorbed by Earth is absorbed at the top (17) of the tropical ocean. The atmosphere 14 does not absorb much sunlight 12 because it is transparent. Sunlight 12 passes through the air and warms the surface of the ocean 13 instead. Most of the ocean 13 is a deep navy blue, almost black and absorbs 98% of the solar radiation when the sun 12 is high.

This ocean storage of heat makes climate change inevitable even if we stopped adding greenhouse gases to the atmosphere 14 immediately. According to the study by a team from the Canadian Centre for Climate Modeling and Analysis (an Environment Canada research lab at the University of Victoria) and the University of Calgary published in the Jan. 9, 2011, edition of Nature, even current levels of carbon dioxide (CO₂) in the Earth's atmosphere 14 will cause unstoppable effects to the climate for at least the next 1,000 years. The study, the first to simulate conditions out to 1,000 years, estimates a collapse of the West Antarctic ice sheet by the year 3000 and an eventual rise in the global sea level of at least four metres.

The Northern Hemisphere fares better than the south in the study, with patterns of climate change reversing within the 1,000-year timeframe in places, such as Canada. At the same time, parts of North Africa experience desertification as land 15 dries out by up to 30 percent and ocean warming of up to 5° C. off of Antarctica is likely to trigger widespread collapse of the West Antarctic ice sheet.

One reason for the variability between the North and South is the slow movement of ocean water from the North Atlantic into the South Atlantic. The global ocean and parts of the Southern Hemisphere have much more inertia, such that changes occurs more slowly and this inertia in intermediate and deep ocean currents driving into the Southern Atlantic means those oceans are only now beginning to warm as a result of CO₂ emissions from the last century. The simulation showed that warming will continue rather than stop or reverse on the 1,000-year time scale.

A viable way to prevent the predicted collapse of the West Antarctic ice sheet is to convert the ocean's excess heat to carbon-free, sustainable, power using OTEC.

Referring to FIG. 2, the ocean's thermocline (20) is the boundary separating the upper mixed layer (21) of the ocean from the calm deep water below (22). It is a thin stratum in which temperature changes more rapidly with depth than it does in the layers above or below.

Water temperature and density share an inverse relationship. As temperature increases, the space between water molecules—also known as density, decreases. If the temperature of a liquid decreases the density will increase. At a temperature of 0° C., with zero movement, water freezes and is at its peak density.

Salinity and density share a positive relationship. As density increases, the amount of salts in the water—also known as salinity, increases. Various events can contribute to change in the density of seawater. Salinity can decrease from the melting of polar ice or increase from the freezing of polar ice. Evaporation increases salinity and density while the addition of freshwater decreases salinity and density.

Seawater is saturated with salts at 35 parts per thousand (ppt). At 4° C. the salinity of seawater is 1.0278 g/cm3 whereas pure water's density is 1 g/cm3 at the same temperature.

Ocean temperatures range from −2° C. to 28° C. in most cases, but are hotter near hydrothermal vents or closer to land. Salinity is usually 35 ppt but can range from 28-41 ppt with the highest salinity in the northern Red Sea.

When the temperature, density or salinity of an ocean layer changes rapidly, this region is referred to as a cline. The ocean thermocline 20 is important due to its effect on planktonic ecosystems. Areas of rapid change in density are pycnoclines and areas of rapid change in salinity are haloclines.

The Nature article, “Global phytoplankton decline over the past century” by Daniel G. Boyce of Dalhousie postulates the volume of phytoplankton in the world's oceans, which are the base of the food chain and produce half of the oxygen (O₂) in the atmosphere by consuming the equivalent amount of CO₂, has been declining steadily for the past half century—down about 40 percent since 1950.

“What we think is happening is that the oceans are becoming more stratified as the water warms,” said Boyce. “The plants need sunlight from above and nutrients from below; and as it becomes more stratified, that limits the availability of nutrients.”

As mentioned above most of the sunlight absorbed on Earth is absorbed by the top of the tropical ocean which is leading to this stratification.

This stratification presents a thermodynamic opportunity because the oceans surface as a heat source and the depths as a heat sink set up ideal conditions for producing power from a heat engine vaporizing and condensing a low-boiling-point fluid.

Referring to FIG. 3, convection is the transfer of heat and mass in the ocean due to diffusion and advection.

Diffusion is the random Brownian motion of individual particles in a fluid and advection is heat transport by the larger-scale motion of currents (30) in the fluid.

Melting polar caps 16 inject cold, heavy water (31) to the world's oceans 13, which sink and flow towards the equator (32) where it is heated by the Sun 12, rises and completes the cycle flowing back towards the poles (33).

Winds (34) contribute to oceanic convection by drawing heat from the ocean's surface (35) into the atmosphere 14 leaving the surface water colder and denser. Denser waters sink and feed into the lower limb of a global system of currents known as the Thermohaline circulation, sometimes called the global conveyor belt, which has great impact on the Earth's climate.

Referring to FIG. 4, Thermohaline circulation (40) is the global density-driven circulation of the oceans 13.

Heat (thermo), and haline (density) are the two main factors determining the density of seawater. As explained above temperature and density share an inverse relationship so when the surface currents, like the Gulf Stream (41), flow towards the poles 33 from the equatorial Atlantic Ocean (42), they are cooled and flow downhill into deep water basins forming the North Atlantic Deep Water (43). These currents resurface in the northeast Pacific Ocean (44) 1,200 years later. Ocean water from all of the ocean basins mixes thoroughly, carrying heat energy and matter in the form of solids and gases, making Earth's ocean a global system.

The deep ocean, devoid of wind, was assumed to be perfectly static by early oceanographers. It has been found however with modern instrumentation that movement in deep water masses is frequent. In contrast to the wind over land, the major driving forces of ocean currents are differences in density and temperature. The density of ocean water is not the same throughout and the thermocline defines the boundary between the upper mixed layer and the deeper cold waters which are separated according to their density.

In order for lighter water masses to float over denser ones, they must flow into position. The shuffling of layers into their most stable positions provides a driving force for deeper currents.

The cold, dense water masses that sink into deep basins are formed in the North Atlantic 43 and the Southern Ocean (45). Seawater is cooled by the wind and the salinity of the water increases due to the salt fraction of the water being left behind when the ice forms.

Extremely dense brine is formed in ice pockets similar to a honeycomb. The brine drips down slowly through the honeycomb matrix and sinks to the sea bottom, flowing downhill through the bottom topography like a stream in the ocean to fill up the polar sea basins.

The cooling effect of the wind is a major factor in the Norwegian Sea and the North Atlantic Deep Water (NADW), where cold dense water fills the basin and spills southwards through crevasses that connect Greenland, Iceland and Britain.

In contrast, in the Weddell Sea located north of Antarctica near the edge of the ice pack, the effect of wind cooling becomes more intense with the exclusion of the brine. The result is the sinking and northward flow of the Antarctic Bottom Water (AABW)—seawater so dense it actually flows underneath the NADW.

The NADW, is the result of density variation in the North Atlantic and is not a static mass of water like once thought, but instead a slowly southward flowing current. The route of the deep water flow is through the Atlantic Basin around South Africa and into the Indian Ocean and on past Australia into the Pacific Ocean Basin. Flow into the Pacific is blocked for both the AABW and the NADW, so the NADW flows very slowly into the deep abyssal plains of the Atlantic always in a southerly direction and the AABW also flows away from the road block. In the case of the AABW, the blockage is the Drake Passage, located between the Antarctic Peninsula and the southernmost tip of South America.

With all the dense water masses sinking in the ocean basins, the original water is moved upwards to keep a balance. Although thermohaline upwelling is a major factor causing ocean currents, it is also a very slow process, even when compared to the movement of bottom water masses. With all of the wind driven processes going on simultaneously, it can be very complicated to determine where upwelling occurs just by using current speeds. So instead, it is necessary to look at the breakdown of particulate matter that falls into the basins over their long journey. By analyzing the chemical and isotopic ratio signatures, the flow rate and age of the deep water masses can be determined. This signature tells us that the surface waters of the North Pacific 44 is where most upwelling occurs.

Thermohaline circulation 40 is responsible for much of the distribution of heat energy from the equatorial oceans to the polar regions of the ocean. It is also the return flow of the sea water from the surface North Atlantic Drift and Gulf Stream currents.

In view of the thermohaline circulation's ability to cause abrupt changes in global climate it is necessary to minimize the impact of an OTEC system on this circulation.

This is accomplished by the current invention by minimizing the heat transfer between warm surface water and cooler, deeper waters, which is the principle driver for thermohaline circulation 40.

Referring to FIG. 5, a conventional OTEC system of the prior art uses the temperature difference that exists between deep, cold, ocean water 22, typically at 5° C. and warm, surface, ocean waters (51), typically about 15° C., but as high as 24° C. in equatorial regions to run a heat engine (52). The working fluid of the system is a low-boiling-point fluid, such as ammonia (53), which is vaporized by the warm water 51, with the vapor driving the heat engine 52, which in turn drives a dynamo (54) to produce electrical energy and the cold deep water then condenses the exhausted low-boiling-point fluid 53 in a condenser (55).

Conventional OTEC has three problems, cost, environmental ramifications and limited capacity. The first two are addressed by a deep water heat pipe as described by British Patent No. GB 2395754. The latter is addressed by the current invention.

As with any heat engine, greater efficiency and power comes from larger temperature differences. This temperature difference between the ocean's surface and depths generally increase with decreasing latitude, i.e. near the equator, in the tropics.

Historically, the main technical challenge of OTEC was to generate significant amounts of power efficiently from small temperature ratios. Modern designs allow performance approaching the theoretical maximum Carnot efficiency.

The Earth is hit with 165,000 terawatts (TW) of solar power every moment of every day. As explained above, the oceans are absorbing part of this energy which is leading to their thermal expansion, which in turn leads to sea level rise.

To give 10 billion people, as is the projected population by the year 2050, the level of energy prosperity the developed world is used to, a couple of kilowatt-hours per person, an additional it has been suggested as much as 60 TW worth of power will need to be generated around the planet.

A recent Nature article, “Robust warming of the global upper ocean” points out that the average amount of energy the ocean has absorbed over the period 1993 to 2008 is enough to power nearly 500 100-watt light bulbs for each of the roughly 6.7 billion people on the planet. This amounts to 330 TW, part of which can be converted to electrical energy to supply the world's energy need by OTEC.

Conventional OTEC faces the drawbacks of high capital cost, environmental impact during installation and use and moderate power outputs.

Current designs use very large and heavy as wells as costly cold and hot water pipes. Heat transfer occurs at the surface requiring the bringing of massive amounts of cold water to the platform deck to condense the working fluid. These cold water pipes are 1000 meters long and have a diameter as great as 10 meters. Marine life entrained in such massive flows is likely to be adversely impacted and the drop in pressure could release dissolved CO₂ into the atmosphere from the cold water. The weight of such massive equipment mandates that the platforms that support them must also be great and therefore costly and mass equates to transportation problems.

Large amounts of seawater are needed to supply a conventional OTEC plants. The discharge expected from a 100 MW OTEC plant is about the size of the flow of the Colorado River into the Pacific Ocean. Cold water exhausted on the surface will draw fish, but the intake of this water from the depths will kill fish eggs and larvae.

In addition CO₂ is more soluble in cold than warm water and accordingly some of the greenhouse gas dissolve in the deep ocean would be released bringing it to the surface.

The deepwater heat pipe described in British Patent No. GB 2395754 necessitates the pumping of a much smaller volume of vaporized ammonia, in a closed system, into the depths to be condensed. No water from the bottom is released into the upper strata of the ocean, trapping all the CO₂ deep beneath the thermocline and no marine life is pumped to the surface.

This solution does not however resolve the problem of the massive of amount of surface heat that must be dumped from the ocean surface to the ocean in the OTEC process and the effect this dumping of heat would have on the Thermohaline circulation.

Referring to FIG. 6, counter-current heat exchange of the prior art shows heat transfer through a thermoconductive interface (60) between two substances moving in opposing direction. FIG. 6 presents a generic representation of this exchange as it would occur in an embodiment of the current invention whereby a vapourized working fluid 53 descends and condenses within the core of a heat pipe and the condensed vapor (62), rising back to the surface, absorbs heat from the descending column. The heat exchanges in accordance with the second law of thermodynamics, in the direction from greatest to least heat.

With opposing flows, the system can maintain a nearly constant heat gradient between the flows over their entire length. With a sufficiently long length and a sufficiently low flow rate this can result in almost total heat transferred from the descending stream to the rising stream. This is made possible by the fact that the heat of condensation of a fluid) is by definition equal to the enthalpy of vaporization with the opposite sign. Enthalpy changes of vaporization are always positive (heat is absorbed by the substance), whereas enthalpy changes of condensation are always negative (heat is released by the substance).

In a counter-current heat exchanger, the hot fluid becomes cold, and the cold fluid becomes hot. At the hot end, hot vapor (63) enters, warming further condensed vapor (64) which has been warmed through the length of the exchanger. Because the hot input is at its maximum temperature, it can warm the condensed vapor to near its own temperature. At the cold end because the condensed vapor (65) entering is still cold, it can extract the last of the heat from the now-cooled condensed vapor (66) in the other section, bringing its temperature down nearly to the level of the cold input fluid.

In accordance with the current invention a heat pipe is a highly efficient method of minimizing the amount of heat that must be extracted from surface waters to vaporize a working fluid in an OTEC system as well as the amount of heat that is dumped into the deep water in order to condense the working fluid vapor.

This is an improvement over conventional OTEC systems which require massive pumping to bring cold water to the surface to condense the working fluid.

It is an improvement over a deepwater condenser in that the amount of heat dumped into the depths is reduced by the recirculation of the majority of the heat extracted from the surface to vaporize the working fluid.

The effect on the thermohaline circulation is therefore also minimized by the reduced effect on both the surface and deep water temperatures.

As with any heat engine, the greatest efficiency and power is produced with the largest temperature difference. The temperature difference between warm, surface, waters and cold, deep, waters at the commencement of producing OTEC power using the current invention is maintained to the maximum extent by recirculation of the surface heat used to drive a turbo generator back to the surface. This recirculation limits the amount of heat dumped into deep water, which would raise the temperature of the deep water, reducing the overall delta T of the system as well as the system's thermodynamic efficiency.

By minimizing the equalization of surface and deep water temperatures through the production of OTEC power using a heat pipe, the amount of energy that can be produced by OTEC from the world's oceans is also maximized. Using the current invention the majority of the global projected need for sustainable energy can be met by OTEC.

Referring to FIG. 7, a heat pipe (70) of the prior art is a device that moves heat rapidly using a liquid-vapor phase change. As a result, heat pipes 70 are able to move heat faster than heat conduction in the best metals.

The conventional notion of a heat pipe 70 is a hollow metal tube (71) with both ends sealed. Inside the tube are a few drops of liquid. As heat is applied to the evaporator region (the hot end) of the tube, the liquid (72) is vaporized. At the condenser region (the cool end) heat is lost and the vapor (73) condenses back into the liquid phase. In the simplest configuration, the evaporator region is placed below the condenser region so that gravity will pull the liquid back down. Depending on the working temperatures, water, alcohol, Freon, sodium, and many other materials can be used as working fluids. The only requirement is that the fluid must be liquid at the condenser region and vapor at the evaporator region. A well known application of a heat pipe is as a cooling device in modern laptop computer where there is insufficient space to blow air over the components but there are other configurations.

A tropical cyclone can be considered an atmospheric heat pipe because it forms when the energy released by the condensation of moisture in a rising column of air causes a positive feedback loop over warm ocean waters.

Without changing its temperature, heat vaporizes water from the ocean's surface. Because humid air is lighter than dry air (simply because water molecules weigh less than nitrogen and O₂ molecules), the humid air rises. As the air rises, it tends to expand and rise faster the higher it rises.

At some point, expansion cools the rising air mass to the point where water begins to condense (forming clouds). Since the energy released is equal to the heat of vaporization, heat has been moved from the surface of the planet to the top of the clouds where some of the heat is reflected into space. The balance is reabsorbed by surrounding water droplets causing them to return to the liquid state, in the case of a cyclone the liquid falls as flooding rain which completes the cycle.

Even though there is no confining tube a cyclone meets the definition of a heat pipe in that it moves heat rapidly using a liquid-vapor phase change. In a severe tropical cyclone the amount of heat transferred is as much as 30 TW.

International patent application WO03025395 to Michaud, describes an Atmospheric Vortex Engine in which a tornado-like convective vortex is produced by admitting air tangentially in the base of a cylindrical wall. The vortex is started by heating the air within the circular wall with fuel. The heat required to sustain the vortex once established can be the naturally occurring heat content of ambient air or can be provided in a peripheral heat exchanger located outside the circular wall. The heat source for the peripheral exchanger can be waste industrial heat or warm sea water. The preferred heat exchange mean is a cross flow wet cooling tower. The mechanical energy is produced in a plurality of peripheral turbines. A vortex engine could have a diameter of 400 m; the vortex could be 100 m in diameter at its base and extend to a height of 1 to 15 km; the power output could be in the 100 to 500 MW range. The vortex process could also be used to produce precipitation, to cool the environment, or to clean or elevate polluted surface air.

The current invention uses the same heat source, warm sea water, and rapid movement of vapor from an evaporator region of a heat pipe to the condenser region to produce energy with a turbo generator. The condensing end of the heat pipe however is located in deep, cold, water rather than the atmosphere.

Typically heat pipes 70 contain no mechanical moving parts. They employ evaporative cooling to transfer thermal energy from one point to another by the evaporation and condensation of a liquid 72 or coolant. Heat pipes rely on a temperature difference between the ends of the pipe, and cannot lower temperatures at either end beyond the ambient temperature (hence they tend to equalize the temperature within the pipe).

When evaporator region of the heat pipe is heated the liquid 72 inside the pipe at that end evaporates and increases the vapor pressure (74) inside the core (75) of the heat pipe. The latent heat of evaporation absorbed by the vaporization of the working fluid reduces the temperature at the evaporator region of the pipe.

The vapor pressure 74 over the hot liquid 72 at the evaporator region of the pipe is higher than the equilibrium vapor pressure (76) over condensing working fluid at the cooler end of the pipe, and this pressure difference drives a rapid mass transfer to the condensing end where the excess vapor condenses, releasing its latent heat, and warms the cool end of the pipe.

The velocity of molecules in a gas is approximately the speed of sound and in the absence of non condensing gases; this is the upper velocity with which gas travels in a heat pipe.

In practice, the speed of the vapor through the heat pipe is dependent on the rate of condensation at the condenser region.

Once condensed the liquid 72 flows back to the evaporator region of the pipe. In the case of vertically-oriented heat pipes containing wicks (77), the fluid is returned by capillary action.

The modern concept for a capillary driven heat pipe was first suggested by R. S. Gaugler of General Motors in 1942 who patented the idea. The benefits of employing capillary action were independently developed and first demonstrated by George Grover at Los Alamos National Laboratory in 1963 and subsequently published in the Journal of Applied Physics in 1964

Over a short distance the “pumping” action of surface tension forces may be sufficient to move liquids from a cold temperature zone to a high temperature zone (with subsequent return in vapor form using as the driving force, the difference in vapor pressure at the two temperatures). Such a closed system, requiring no moving parts, was found to be useful in space reactors in moving heat from the reactor core to a radiating system because in the absence of gravity, the forces must only be such as to overcome the capillary and the drag of the returning vapor through its channels.

In the current invention which comprises an OTEC system utilizing a heat pipe, the forces of gravity would have to be overcome to return the condensed working fluid from the ocean's depths to its surface.

Trees accomplish this through transpirational pull as water evaporating from the leaves cause millions of minute menisci to form in the cell wall of the leaf. The resulting surface tension causes a negative pressure or tension in the xylem (comparable to the heat pipe wick) of the tree which pulls the water from the roots and soil.

A large oak tree can transpire as much as 40,000 gallons of water through it leaves in a year

Due to the volume of working fluid that must be vaporized to produce OTEC power and the speed with which the vaporized fluid would need to be replaced, pumping would be required to move the required amount of condensed working fluid.

According to a 2010 study by Luis A. Vega, National Marine Renewable Energy Center at the University of Hawaii and Dominic Michaelis, Energy Island Ltd., a Closed Cycle OTEC with a net production output of 53.5 MW would require a throughput of 2,750 kg/s of anhydrous ammonia. This is an order of magnitude four times great than the fluid moved in the oak tree referred to above.

The specific gravity of anhydrous ammonia is 682/kg/m3, so 2750 kg equates to about 4 m3 worth of anhydrous ammonia.

Conventional OTEC requires the movement of 150 m3/s of cold water through a cold water pipe to produce 50 MW so there is a near 3700% efficiency gain with the current invention.

The current inventions effects the condensation of a working fluid vapor in a heat pipe without the need for pumping cold water to the surface from great depths, as occurs in conventional OTEC systems and accordingly avoids possible risk of environmental damage that such pumping would entail.

The avoidance of the need to pump massive amounts of cold water further reduces the cost of conventional OTEC by reducing the need for massive surface structures to support cold water pumping infrastructure, a cold water pipe, a cold water return pipe and a heat pipe cleaning system. The capacity and mass of the heat pipe pump that would be required is also much less than is required by a conventional system.

A heat pipe improves the overall efficiency of an OTEC system by eliminating the parasitic losses due to cold water pumping.

The heat pipe is an extremely effective device for transmitting heat. In equilibrium, the heat input equals the heat output. In the current invention the heat pipe would be tuned to operate as close to equilibrium as possible with the result the amount of heat extracted from the surface to produce OTEC power would be close to the amount of heat that would be dumped into ocean depths.

Producing 60 TW of electrical energy with the current invention requires 120 TW of surface heat of which 60 TW would be dumped into deep water with minimal effect on the Thermohaline circulation.

As shown above a severe tropical cyclone transfers as much as 30 TW worth of heat from the surface of the ocean to the atmosphere and on average there are 21category 3 or greater cyclones around the globe each year and many more smaller storms.

Referring to FIG. 8, a schematic is shown of the oceanic food cycle.

As explained above, it is believed the stocks of phytoplankton (80) in the ocean are declining due to the increasing thermal stratification (81) of the oceans 13 due to global warming.

If the planet continues to warm in line with projections of computer models of climate, the overall decline in phytoplankton 80 might be expected to continue, but such a decline is not certain.

If such a decline does occur however, it would mean less carbon capture and storage would occur in the open ocean and there would be a negative impact on fish stocks which exist on phytoplankton 80 directly or on marine life (82) that depend on phytoplankton 80 at the base of their food cycle.

The relationship between phytoplankton 80 and the human food chain has recently been demonstrated by the massive 34 million run of Sockeye to the Fraser River in 2010.

Dr. Tim Parsons, Institute of Ocean Sciences in Sidney, believes the 2008 eruption of the Kasatochi volcano in Alaska helped produce B.C.'s largest run since 1913 because the salmon that returned in 2010 were “adolescents” in the Gulf of Alaska when the volcano erupted and the volcano's ash fed a massive bloom of phytoplankton 80 which nourished the fish.

Producing conventional OTEC power the ocean would reduce the stratification 81 of the ocean by making it more isothermal vertically as more energy was extracted pumping heat into the depths. Nutrients (83) from the deep would first fertilize surface plankton 80 but then would eutrophy the water column, much as fertilizer and detergent runoff from terrestrial rivers do, creating massive dead zones.

An ocean thermal energy conversion counter-current heat transfer system embodied by the current invention would transfer heat from the surface to deep water at a depth of about 1000 meters. The average depth of the oceans 13 is approximately 4000 meters. As explained above warm water is less dense than cold water. The water so warmed by the transferred heat would gradually rise due to its loss of density and this gradual upwelling, with deep water nutrients 83 entrained, would sustain increased phytoplankton populations in the upper layer where the phytoplankton depend on sunlight 12 to sustain photosynthesis, as well as the nutrients 83.

This upwelling of nutrients would be far more subtle than the massive upwelling induced by conventional OTEC cold water flows and therefore would not have the same eutrophying effect on the water column. It would however have a positive effect on phytoplankton growth as well as the marine life which depend for their existence on the phytoplankton.

Increased phytoplankton 80 stocks nurtured by the upwelling of nutrients 83 would have positive consequences for the amount of CO₂ (84) the oceans 13 are able to absorb and the O₂ (85) content of the atmosphere, 40 percent of which is derived from the photosynthesis of the ocean's phytoplankton 80.

Referring to FIG. 9, a sectional elevation of an OTEC system utilizing a counter-current heat transfer system is shown. The counter-current heat pipe (90) is comprised of a core 75, a return channel (91) and a thermoconductive interface 60. The OTEC system is comprised of an upper platform (92) in which a heat engine 52 and dynamo 54 are mounted. A low boiling point working fluid 53 is vaporized by absorbing a latent heat of evaporation from warm surface waters at the evaporator region of the heat pipe 70. The vapor (96) drives a heat engine 52 mounted within the core 75 of the heat pipe 70, which in turn produces electrical energy in the dynamo 54. The vapor 96 transfers down the core 75 to the lower end of the heat pipe situated in deep, cold, water wherein the vapor is condensed in the condenser region of the heat pipe to fluid 53 and is returned by a pump (94), within a channel to the evaporator end of the heat pipe to complete the cycle. The interface 60 between the heat pipe core 75 and the channel 91 is thermally conductive allowing heat of condensation of the descending vapor to be transferred through the interface to the working fluid 53 within the channel 91, which absorbs the latent heat of condensation and returns the working fluid 53 preheated to the surface.

FIG. 9 shows the channel 91 on the outside of the core 75, but in some embodiments of the current invention it maybe advantageous to locate the channel 91 within the core 75.

It may also be advantageous to pump the condensed working fluid 53 to the surface in a pipe other than the return channel 91.

This is an improvement over the current art in that it minimizes the amount of heat that must be extracted from surface waters to vaporize a working fluid as well as the amount of heat that is dumped into the deep water in to condense the working fluid vapor.

It is a further improvement in that the overall efficiency of OTEC power generation is increased making it more viable in comparison with other energy sources and it causes less environmental disturbance than its conventional counterparts.

The current invention greatly reduces the cost of a conventional OTEC system by eliminating the need for a massive cold water pipe, a cold water return pipe, heat pipe pumps as well as the cleaning system for the heat pipe, which is required when the heat pipe operates in shallow waters and is thus subject to bio-fouling, which is not a concern in deep, cold water.

The elimination of the need for this equipment increases the overall efficiency of the OTEC system, reduces parasitic losses in the operation of the system as well the complexity and mass of the system.

Referring to FIG. 10, a plan view of the upper section an OTEC system utilizing a counter-current heat transfer system is presented showing the floor of the upper platform 100, the dynamo 54, the heat engine 52, the vains of the heat engine 110 and the working fluid vapor 96.

The embodiments of the invention in which an exclusive property or privilege is claimed are defined as follows:

1. An ocean thermal energy conversion counter-current heat transfer system for minimizing relocation of heat from near the ocean surface to a location far below the ocean surface, comprising a heat pipe with an evaporator region, which uses warm ocean water near the ocean surface to provide heat for evaporating a low-boiling-point working fluid to produce a vapor; and a core for conducting the vapor to a condenser region at the opposite end far below the ocean surface, which uses cold ocean water for the purpose of condensing the vapor back to a liquid, and a channel and a pump for moving the liquid back to the evaporator region in a counter-current flow, which maintains a heat gradient between a vapor phase and liquid phase of the working fluid the length of the heat pipe, and a thermally conductive interface between the core and the channel, which conveys a heat of condensation of the vapor through the interface to the channel; wherein a low-boiling-point working fluid absorbs a latent heat of evaporation from warm ocean water to produce a vapor, and wherein a condensed working fluid in a counter-current flow within the channel absorbs a latent heat of condensation released by the condensing vapor and returns preheated to the evaporator region of the heat pipe to complete the cycle.

2. An ocean thermal energy conversion counter-current heat transfer system, as claimed in claim 1 which effects the condensation of the working fluid without pumping cold water to the surface from great depths, as occurs in conventional ocean thermal energy conversion systems, and thus avoids the risk of environmental damage pumping entails.

3. An ocean thermal energy conversion counter-current heat transfer system, as claimed in claim 1 wherein the preheated condensed working fluid requires less heat from warm ocean water near the ocean surface to evaporate a low-boiling-point working fluid to produce a vapor.

4. An ocean thermal energy conversion counter-current heat transfer system, as claimed in claim 1 whereby the latent heat of condensation of the vapor conveyed through an interface to a working fluid vapor returning to an evaporator region of a heat pipe reduces an amount of heat relocated from near the ocean surface to cold ocean water far below the ocean surface.

5. A cost effective heat transfer minimizing ocean thermal energy conversion system as claimed in claim 2 in which an avoidance of pumping cold water reduces cost and a need for massive surface structures to support a pumping infrastructure.

6. An ocean thermal energy conversion counter-current heat transfer system as claimed in claim 2 wherein efficiency of a system is improved and a potential for parasitic losses are reduced over conventional ocean thermal energy conversion systems through the elimination of a cold pump, a cold water pipe, a cold water return pipe, heat pipe pumps and a heat pipe cleaning system.

7. An ocean thermal energy conversion counter-current heat transfer system as claimed in claim 2 wherein power losses due to pumping surface and deep fluids are reduced over conventional ocean thermal energy conversion systems.

8. An ocean thermal energy conversion counter-current heat transfer system as claimed in claims 3 and 4 that maximizes thermodynamic efficiency by reducing heat transfer between warm surface water and cold ocean water far below the ocean surface.

9. An ocean thermal energy conversion counter-current heat transfer system as claimed in claim 4 whereby heat relocated from near the ocean surface to water far below the ocean surface is sufficient to reduce the density of the water far below the surface causing it to rise in a water column.

10. An oceanic thermal energy conversion system as claimed in claim 8 which maximizes an amount of work that can be extracted from an ocean by reducing the heat transfer between warm surface water and cold ocean water far below the ocean surface.

11. An ocean thermal energy conversion counter-current heat transfer system as claimed in claim 8 wherein a potential for disrupting thermohaline circulation as occurs in conventional ocean thermal energy conversion systems is minimized by reducing the heat transfer between warm surface water and cold ocean water far below the ocean surface.

12. An ocean thermal energy conversion counter-current heat transfer system as claimed in claim 9 wherein the rising column of water contains nutrients in sufficient quantity to sustain phytoplankton life near an ocean's surface.

13. An ocean thermal energy conversion counter-current heat transfer system as claimed in claim 10 that enables sufficient work to be converted to electrical energy to meet a future projected need for sustainable energy.

14. An ocean thermal energy conversion counter-current heat transfer system as claimed in claim 11 which minimizes climate effects due to thermohaline circulation disruption.

15. An ocean thermal energy conversion counter-current heat transfer system as claimed in claim 12 wherein the phytoplankton sustain zooplankton and other aquatic life in greater quantities than would be the case were the nutrients unavailable.

16. An ocean thermal energy conversion counter-current heat transfer system as claimed in claim 12 wherein the phytoplankton consume more carbon dioxide and produces more oxygen than would be the case were the nutrients unavailable.

17. An ocean thermal energy conversion counter-current heat transfer system as claimed in claim 12 wherein the phytoplankton life is insufficient to eutrophy the water column upon the death of the phytoplankton.
